(19) United States
(12) Patent Application Publication
(10) Pub. No.: US 2016/0343274 A1
(43) Pub. Date: Nov. 24, 2016

(54) CARD THAT STANDS PERPENDICULAR TO A HORIZONTAL SURFACE

(71) Applicant: Daniel Irwin Stusser, Olympia, WA (US)

(72) Inventor: Daniel Irwin Stusser, Olympia, WA (US)

(21) Appl. No.: 14/718,058

(22) Filed: May 20, 2015

(51) Int. Cl. G09F 1/10

(52) U.S. Cl. CPC G09F 1/10

(57) ABSTRACT

The present invention is a card that stands perpendicular to a horizontal surface. The card is made up of a single piece of material on which graphic images and letters have been printed and which has been specially shaped and pre-creased to enable a recipient to fold the base part of it so that the display part will rise up perpendicular to or at a raked angle from the horizontal surface on which it is placed.

### CROSS REFERENCE TO RELATED APPLICATION

This application claims the benefit of provisional patent application No. 62/000,675, filed 2014 May 20 by the present inventor.

### FEDERALLY SPONSORED RESEARCH

None.

### SEQUENCE LISTING

None.

### BACKGROUND

The present invention is a Card that stands perpendicular to a horizontal surface. The card is made up of a single piece of material on which graphic images and letters have been printed and which has been specially shaped, cut, and pre-creased to enable a recipient to fold the base part of it so that the display part will rise up perpendicular to, or at a raked angle from, the horizontal surface on which it is placed.

### Prior Art

Prior similar articles have been A) more complex, B) more expensive, C) have not been designed to allow for small-size embodiments, D) are difficult to transport in large quantities, and E) are not designed to appeal to specific markets.

The present invention solves these issues.

Both U.S. Pat. No. 1,947,521 to Einson (1934) and U.S. Pat. No. 2,815,597 to Carter (1957) show countertop displays. Both are more complex to manufacture and erect than the present invention, requiring the construction of an easel. Both require much more display space in their smallest embodiments. The present invention can be made as small as a centimeter square, but is currently made in the size of a conventional business card (2″×3.5″) or greeting card (approximately 5″×8″) in most situations. It stands unaided by any additional attachment, spar or easel.

One method that allows for the perpendicular display of an image is that shown in U.S. Pat. No. 5,010,669 to Moran (1991) in which a four-panel box has a perforation from which the image can be punched out. The present invention uses less than half of the material for a comparable size display and, in most embodiments, requires no punching out of a perforated image.

Other single-part cards that are designed to be deployed quickly require specialized structures below them to stand perpendicular. U.S. Pat. No. 4,246,711 (1920) to Sargent and U.S. Pat. No. 2,651,862 (1953) to Fine show simple displays that are designed to be placed on top of long-neck bottles and gable-topped milk cartons, respectively.

U.S. Pat. No. 2,530,950 (1950) to Benchley shows a two-sided display that requires several folds, a slit and a tab to accomplish what the present invention delivers without these complexities.

Currently there are a number of solutions for a card that stands perpendicular to a horizontal surface. Further, there are a number of conventional solutions for bringing attention to printed advertisements. Some of these solutions attempt to bring attention through graphic design or surface treatments, but these solutions fail to meet the needs of industry because these conventional business cards, postcards and other traditional flat advertising pieces are not designed to be displayed easily or viewed repeatedly. Most such pieces are quickly filed away or destroyed. It is desirable for any advertising to offer repetitive exposures for the advertiser.

Since conventional business cards, post cards and other small advertising displays lack any feature of uniqueness once they have been conveyed their greeting, they retain little impact and are often soon discarded. Therefore, there currently exists a need in the advertising industry for a Card that Stands Perpendicular to a Horizontal Surface.

### Advantages

The present invention delivers several advantages over prior art.

### Simplicity

The present invention enables the recipient of such a piece to easily and quickly display it perpendicular to a counter, desktop or shelf, which in turn makes the advertising message available for many repetitive viewings. The present invention requires no instructions and takes as little as one second to deploy.

It would be desirable to have a business card, rack card, sign or other advertising display, that enables the recipient to display it on a desk, counter or shelf, without the need to use adhesive tape, construct an easel, attach external stands or use fasteners such as nails or tacks.

### Price Advantage

Competitive products, including distinctively printed advertising cards, countertop displays, and promotional products, usually have multiple parts and, accordingly, are usually priced much higher than the present invention.

The present invention is a single part, made of conventional modern materials.

### Size Advantage

The size of the Card will vary depending on the rigidity of the material from which it is made, from something as small as a square centimeter to as large will fit through a conventional doorway.

The ratio of the height of the Display Panel of the card to Base part(s) will vary according to the need of the advertiser, and

The shape of the Display Panel and Base part(s) will vary according to the requirements of the customer.

### Simple to Transport

Non-flat advertising tools, such as countertop displays and promotional products, are often bulky and cannot be easily carried in significant numbers. The present invention is available in various sizes, the smaller of which can be carried by an individual by the hundreds of pieces.

### Target Markets

Other solutions attempt to provide temporary entertainment value or reference information, but these solutions are similarly unable to meet the needs of the industry because they do not solve the problem of how to generate repeated exposures.

This is particularly true for advertising that features a popular image, such as a brand mascot or iconic character, or a portrait of an entertainer, author, speaker or other featured individual.

The present invention advantageously fills the aforementioned deficiencies by providing a Card that can be designed in an unlimited number of two-dimensional shapes, including those that emphasize popular image, such as a brand mascot or iconic character, or a portrait of an entertainer, author, speaker or other featured individual.

The present invention provides a new and unique way for general business advertisers, restaurant businesses, non-profit organizations, sports teams, and celebrities to have a fully customized Card that has none of the disadvantages of prior art.

The present invention can be customized in unlimited ways, including as a mailing piece, sales brochure, business card, safety information card, menu, game piece, souvenir, and autograph card.

The present invention is unique in that it is structurally different from other known devices or solutions. More specifically, the present invention is unique due to the presence of:

(1) a Crease 04 to enable easy and accurate folding;
(2) a Base section designed to enable the Main Display Panel to stand upright;
(3) Custom shaping for the Display and/or Base sections to differentiate the piece from any other advertising cards; and
(4) only a simple, single piece of stock, with no need for any adhesives, external stands, instructions or tools with which to assemble it.

Among other things, it is an object of the present invention to provide a card that stands perpendicular to a horizontal surface that does not suffer from any of the problems or deficiencies associated with prior solutions.

It is still further an object of the present invention to create a device that is more easily displayed.

Further still, it is an object of the present invention to create a device that leverages the special graphic images of customers.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### DESCRIPTION OF THE DRAWINGS

The drawings show examples of said Card from three views and in three embodiments. Closely related figures have the same number but different alphabetic suffixes.

### FIGURES

### Tripod Base Embodiment

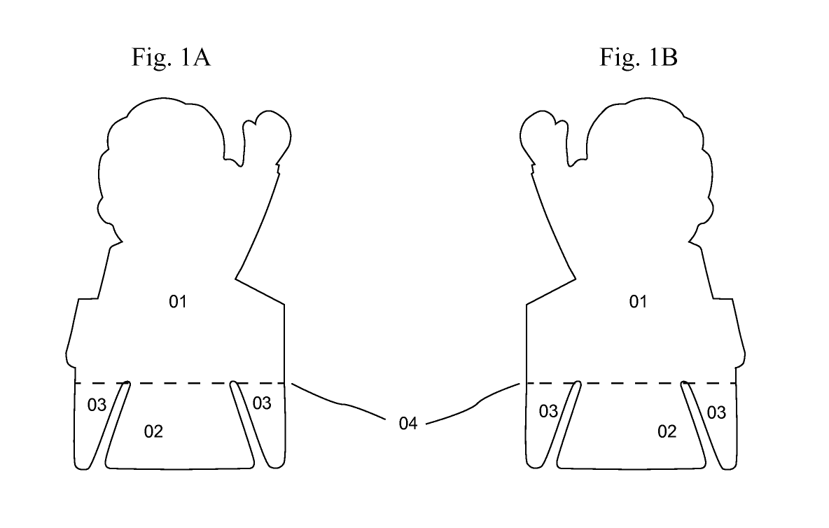

FIGS. 1A and 1B show the Card with a Display Panel 01, Tripod Base parts Lower Display Panel 02 (trapezoid-shaped) and Outer Tabs 03 (triangle-shaped), and crease 04. Crease 04 is shown in the dashed line. FIG. 1A is the obverse side. FIG. 1B is the reverse side. These examples are shown as if laying flat, not folded or standing.

### Box-in-Box Embodiment

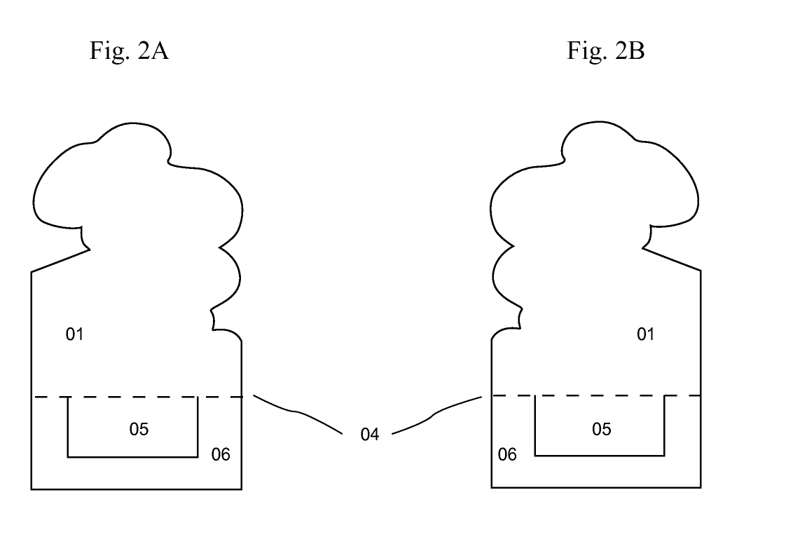

FIGS. 2A and 2B show the Card with a Display Panel 01, Box-in-Box Base parts Inner Box Panel 05 and Outer Box Ring 06, and crease 04. Crease 04 is shown in the dashed line. FIG. 2A is the obverse side. FIG. 2B is the reverse side. These examples are shown as if laying flat, not folded or standing.

### Custom Box Embodiment

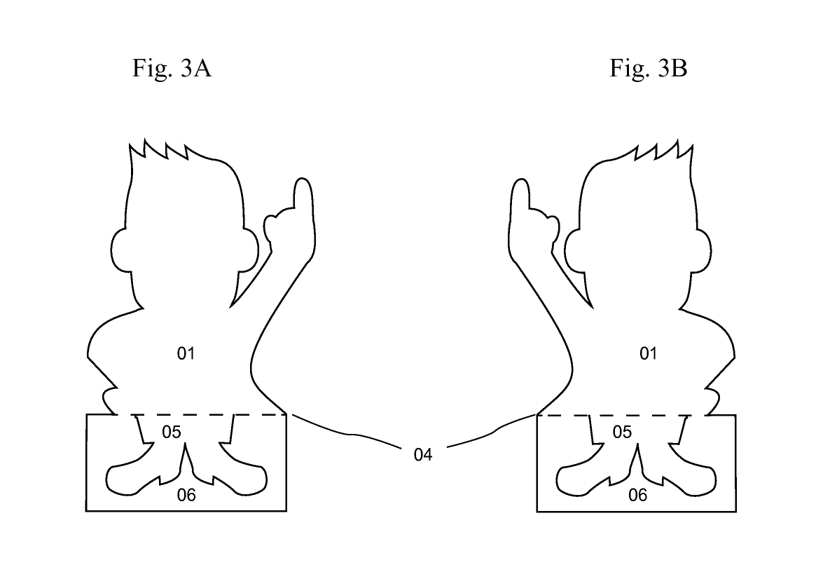

FIGS. 3A and 3B show the Card with a Display Panel 01, Custom-Box Base parts Inner Box Panel 05 and Outer Box Ring 06, and crease 04. Crease 04 is shown in the dashed line. FIG. 3A is the obverse side. FIG. 3B is the reverse side. These examples are shown as if laying flat, not folded or standing.

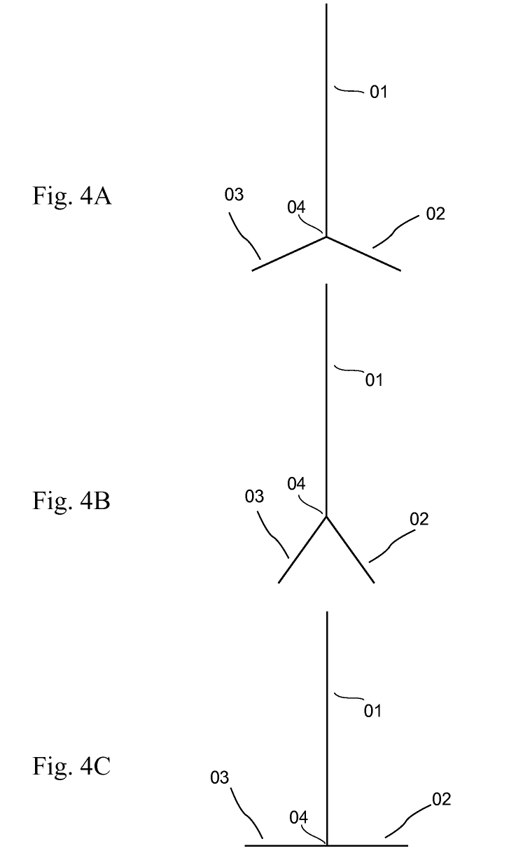

FIGS. 4A, 4B and 4C show the side view of the Card, with Tripod Base as in FIGS. 1A and 1B, standing perpendicular to a horizontal surface. Tripod Base parts Lower Display Panel 02 and Outer Tabs 03 are the same height from the bottom of the Card. FIG. 4A shows the Card with the Base at the tallest position, with the Base parts bent at approximately 45 degrees from Display Panel 01. FIG. 4B shows the Base at a middle position, bent at about 75 degrees from Display Panel 01. FIG. 4C shows the Base at a lowest position, with the base parts bent at a 90 degree angle from the display panel, perpendicular to the Display Panel and flat against the surface upon which said Card is displayed.

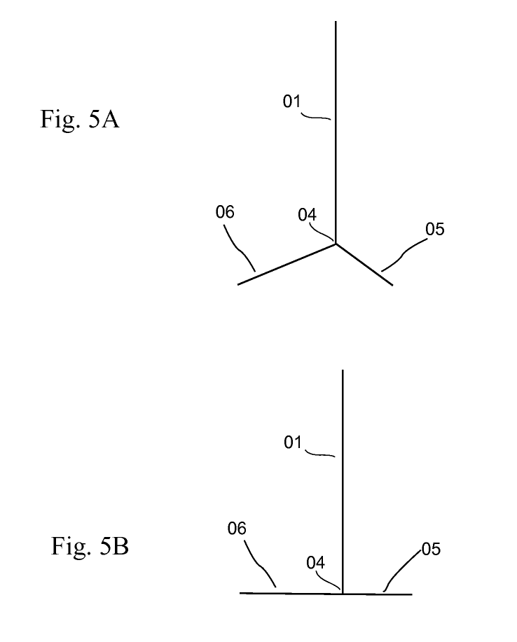

FIGS. 5A and 5B show side view of the Card, with Box-in-Box Base as in FIGS. 2A and 2B, standing perpendicular to a horizontal surface. Base parts 05 and 06, are cut at different heights from the bottom of the Card. FIG. 5A shows the Card with the Base at a middle position, with the Base parts bent at different angles from the display panel to enable Display Panel 01 to stand perpendicular to the surface upon which said Card is displayed. FIG. 5B shows Base parts 05 and 06 at their lowest position, bent at a 90 degree angle from the Display Panel, perpendicular to the Display Panel and flat against the surface upon which said Card is displayed.

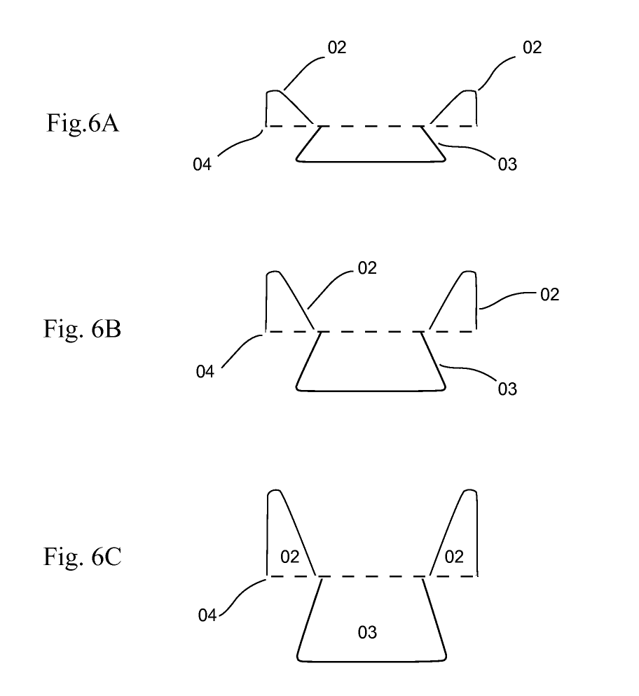

FIGS. 6A, 6B and 6C show the top-down view of the Card, with Tripod base as in FIGS. 1A and 1B, standing perpendicular to a horizontal surface. FIG. 6A is the top-down view of FIG. 4A; FIG. 6B is the top-down view of FIG. 4B, FIG. 6C is the top-down view of FIG. 4C.

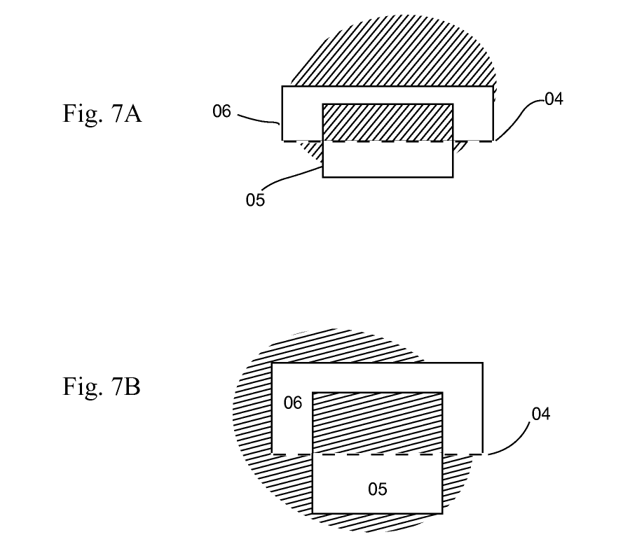

FIGS. 7A and 7B show the top-down view of the Card, with Box-in-Box base as in FIGS. 2A and 2B, standing perpendicular to a horizontal surface. FIG. 7A is the top-down view of FIG. 5A; FIG. 7B is the top-down view of FIG. 5B. The shaded area represents the surface upon which said Card is placed and shows the hollowed out area that is exposed when Base part 05 is bent in opposition to Base part 06.

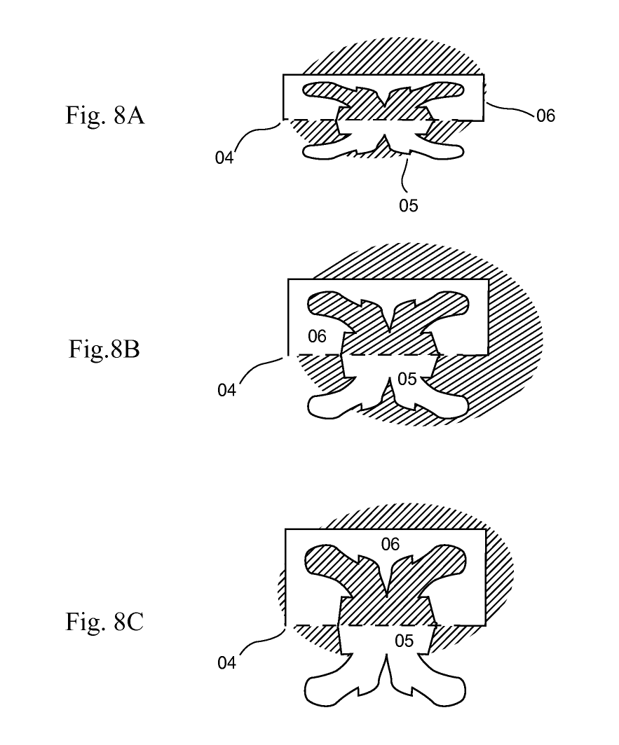

FIGS. 8A, 8B and 8C show the top-down view of the Card, with Custom-Box base as in FIGS. 3A and 3B, standing perpendicular to a horizontal surface. The shaded area represents the surface upon which said Card is placed and shows the hollowed out area that is exposed when Base part 05 is bent in opposition to Base part 06.

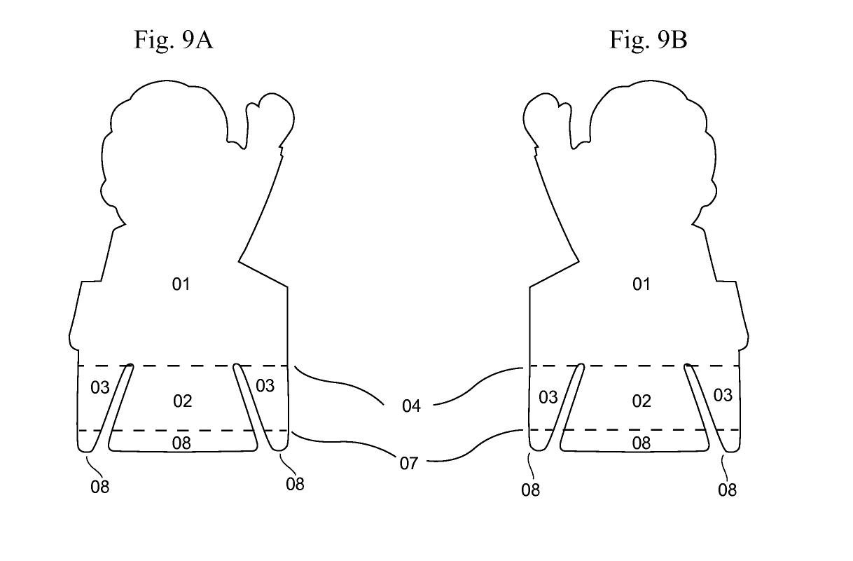

FIGS. 9A, 9B, 10A, 10B, 10C, 11A, 11B and 11C show a modified embodiment of said Card as in FIGS. 1A and 1B with an additional a second crease (Crease 07) parallel to the first crease, is added to the base component to create a flange or foot.

FIGS. 9A and 9B show said Card as if laying flat, not folded or standing. Crease 07 is shown unbent. Crease 07 creates Foot 08.

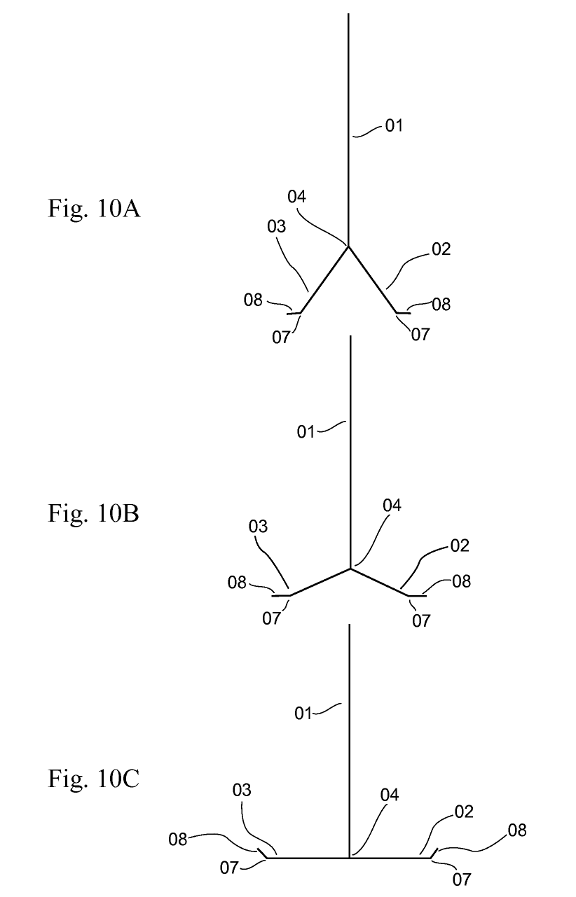

FIGS. 10A, 10B and 10C show the side view of said Card, standing. FIGS. 10A and 10B show the Crease 07 bent to allow Foot 08 it creates to be positioned flat on the horizontal surface. FIG. 10C shows Crease 07 bent, with the foot slightly raised from the horizontal surface.

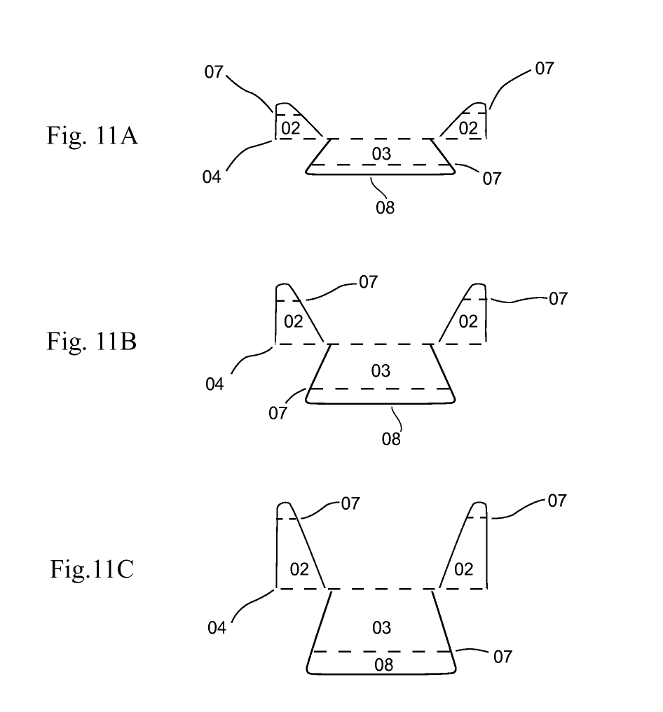

FIGS. 11A, 11B and 11C show the top-down view of the card with Crease 04 bent at different angles as in FIGS. 6A, 6B and 6C, with the additional Crease 07 creating Foot 08.

### REFERENCE NUMBERS

01 Display Panel
02 Base part Lower Display Panel
03 Base parts Outer Tabs
04 Crease
05 Box-in-Box Base part Inner Box Panel
06 Box-in-Box Base part Outer Box Ring
07 Optional Crease
08 Foot

1. A card that stands perpendicular to a horizontal surface, comprising
a) a single sheet of semi-rigid, flexible material,
b) said sheet being modified so that at least one crease is added that creates a hinge to differentiate between
1) a main display panel, and
2) a bifurcated Base that enables the main display panel to stand perpendicular or raked in perspective to the surface upon which it is placed,

2. A Card as recited in claim 1 and below, wherein the semi-rigid material is at least one of the following materials: paper card stock made of wood fibers, other natural fibers or man-made fibers, plastic card stock, metal plate, metal sheet, metal foil, 3-D printing plastic or composite sheets comprising various flexible and rigid materials.

3. A Card as recited in claim 1 and below, wherein the semi-rigid material is printed or imprinted using at least one of the following methods: offset lithography, digital toner printing, xerography, ink jet printing, LED printing, silk screening using ink, paint or dyes, dye sublimation, photographic printing, foil stamping, foil or other imprinting, letterpress, debossing, embossing, laser etching, laser imprinting, laser burning, rubber die imprinting, hand inking, hand painting, ultraviolet coating.

4. A Card as recited in claim 1 and below, wherein the semi-rigid material is creased using of the following technologies: manual creasing, hand creasing, cutting plotter, electric scoring machine, letterpress, die matrix on offset press, cylinder press, rotary die cutting, flexible die, micro-slitting, laser etching.

5. A Card as recited in claim 1 and below, wherein the semi-rigid material is cut to shape using one of the following technologies: hand cutting, digital contour cutting, cutting plotter, dinking, steel-rule die, letterpress, cylinder press, rotary die cutting, flexible die, rotary magnetic cylinder die cutting, laser cutting or extrusion.

6. A Card as recited in claim 1 and below, wherein the semi-rigid material is cut to any size, from as small as one centimeter to as large as the material will allow unsupported standing perpendicular to the surface upon which said Card is placed.

7. A Card as recited in claim 1 and below, wherein a second or additional crease, parallel to the first crease, is added to the base component to create a flange or foot, as shown in FIGS. 9A through 11C.

8. A Card as recited in claim 1 and below, which is embedded into a larger sheet of the same semi-rigid material, which is pre-creased but not cut into the shape described by the graphics printed on it. Instead of being cut to shape, there are perforations designed to let the recipient of said piece to punch out the Card that Stands Perpendicular to a Horizontal Surface.
